(19) United States
(12) Patent Application Publication
(10) Pub. No.: US 2019/0117024 A1
(43) Pub. Date: Apr. 25, 2019

(54) CLEANSING DEVICE AND KIT

(71) Applicant: Medline Industries, Inc., Northfield, IL (US)

(72) Inventors: Michelle Christiansen, Johnsburg, IL (US); Jacob Floski, Buffalo Grove, IL (US); Jeremy Fogel, Evanston, IL (US)

(21) Appl. No.: 15/793,956

(22) Filed: Oct. 25, 2017

(51) Int. Cl. A47K 7/02; A61G 7/00

(52) U.S. Cl. CPC A47K 7/022; A61G 7/0005; A61Q 19/10; A47K 7/026; A47K 7/028

(57) ABSTRACT

A cleansing device for human extremities has a tubular section comprising a water-absorbent material; and a dry cleansing composition impregnated into the tubular section, wherein the tubular section comprises at least one open end, whereby the tubular section is adapted for insertion of a human extremity (limb) into the tubular section through the at least one open end.

### TECHNICAL FIELD

The present disclosure relates generally to patient hygiene, and more specifically to cleansing devices and methods for patients unable to cleanse themselves.

### BACKGROUND

Health caregivers are responsible for washing and bathing patients. This can be particularly challenging when the patient is confined to a bed or wheelchair. Patients who are recovering from surgery, for example, or who are otherwise unable to stand without assistance, are often unable to bathe or shower using conventional bathing or showering facilities. The hands and feet of the patient are particularly important to clean, since they often are a source of transfer or transport for pathogens. Generally, cleansing of the hands and feet, requires rinsing the hands or feet with running water and working a cleanser into the skin, particularly between the fingers or toes.

Some patients are not able to wash their own foot or hand, due, for example, to their being confined in bed, and therefore unable to move to where running water is available. It is not always easy to cleanse the patient's hands and feet in such cases. To do so, a caregiver may fill a basin with water, and a washcloth may be used with soap to clean the patient's hands and feet. This process is not ideal, because the basin is easily spilled, and the process can leave the patient's garments and bedding wet from spillage.

It has now been found that a cleansing sleeve for human extremities can assist in washing the hands or feet of a patient. The sleeve includes a tubular section comprising a water-absorbent material; and a dry cleansing composition impregnated into the tubular section, wherein the tubular section comprises at least one open end, whereby the tubular section is adapted for insertion of a human extremity into the tubular section through the at least one open end. Water may be added to the device to moisten the cleansing composition, the cleansing composition preferably being water-soluble at least in part, to thereby form a cleansing composition in situ in the sleeve. Preferably, the cleansing composition is at least substantially completely water soluble.

In accordance with some embodiments, a method for cleansing a human extremity is provided, the method comprising providing a cleansing device that includes a water-impermeable package and a cleansing sleeve. The device is opened, and water is added to the sleeve to activate a dry cleansing composition impregnated therewithin. A tubular section of the sleeve is placed over the patient's hand or foot. Preferably, the caregiver manually kneads the tubular section to introduce the cleansing composition onto the skin of the human extremity, especially within the fingers or toes as applicable.

Also contemplated in some embodiments is a method for preparing a cleansing device, the method including introducing a cleansing solution into a water-absorbent sleeve, allowing the cleansing solution to impregnate the sleeve, allowing the cleansing solution to dry, and packaging the cleansing sleeve within a water-impermeable package.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a perspective view of a cleansing sleeve in accordance with an embodiment of the present disclosure.

FIG. 2 is a perspective view of the cleansing sleeve of FIG. 1 packaged within a water impermeable package.

FIG. 3 is a representational view illustrating of a cleansing sleeve kit including a pair of cleansing sleeves as shown in FIG. 1.

FIG. 4 is a perspective view of the cleansing sleeve of FIG. 1 disposed on a patient's hand.

FIG. 5 is a flow chart illustrating a method of using the cleansing sleeve of FIG. 2;

FIG. 6 is a flow chart illustrating another method of using the cleansing sleeve of FIGS. 2 and 3;

FIG. 7 is a perspective view of a second embodiment of a cleansing sleeve in accordance with the present disclosure.

FIG. 8 is a perspective view of the cleansing sleeve of FIG. 5 packaged within a water-impermeable package.

FIG. 9 is a perspective view of the cleansing sleeve of FIG. 5 on a patient's hand.

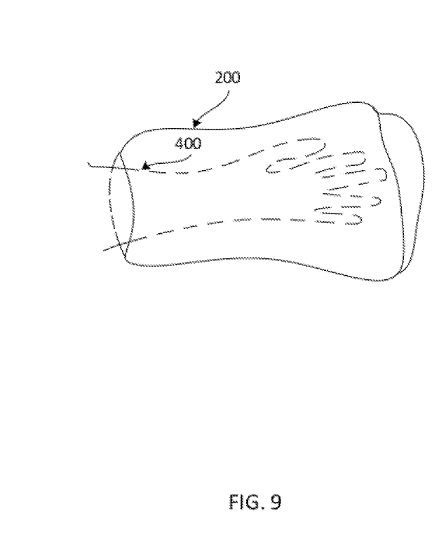

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments of the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

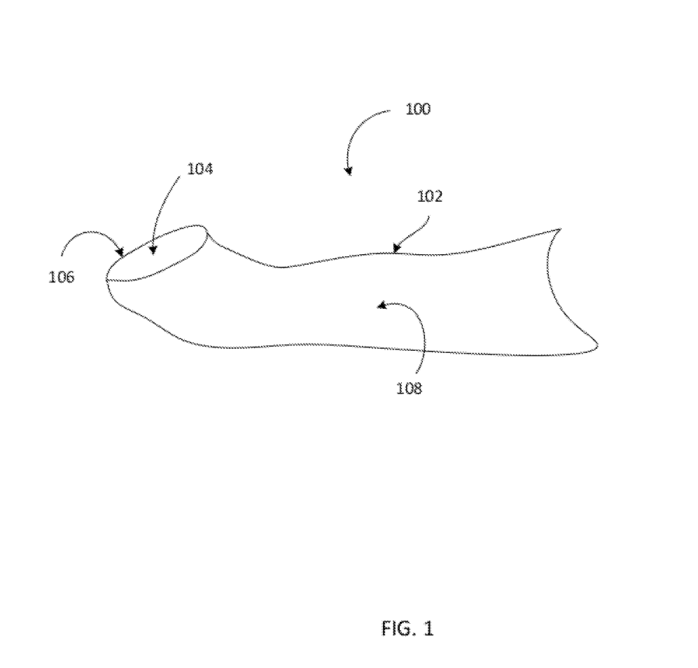

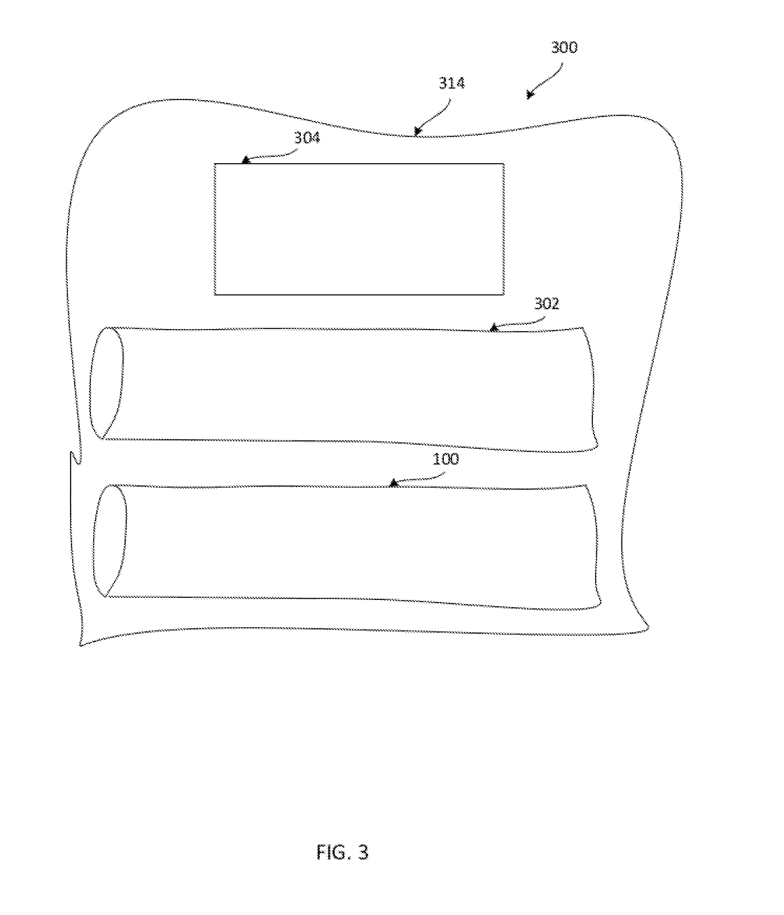

Referring first to FIG. 1, the illustrated cleansing sleeve 100 comprises a tubular pocket 102 and an opening 104 sized to accommodate the patient's extremity, such as a hand (see FIG. 3) or foot. Any suitable morphology for the cleansing device may be used. When in the form of a cleansing sleeve for the hand, the sleeve may be generally elongate and the diameter of the opening 104 may be, for example, less than about half of the length of the cleansing sleeve 100 and is sized to encircle, for example, a human hand. A sleeve designed for the human foot may be identically sized or may be sized and shaped more specifically to accommodate a human foot. As shown, the opening 104 includes optional elastic 106 encircling the opening 104 to secure the opening 104 at the patient's skin.

The sleeve is made from material such a blend of nonwoven polyester fibers, or other water-absorbing material. The material forming the sleeve may have any suitable basis weight. Optionally, a water-impermeable cover (not shown) may be provided.

The pocket is impregnated with a dry cleansing composition 108. The dry cleansing composition 108 comprises a surfactant that may provide lathering properties. Suitable cleansing compositions include, for example, surfactant and other ingredients such as preservatives and fragrances. As provided, the cleansing composition preferably is substantially completely dry. In manufacturing the sleeve, the cleansing composition may be introduced by dipping the sleeve into a solution of cleansing composition and allowing the cleansing composition to dry.

Any suitable lathering surfactants may be used. Exemplary surfactants include one or more imidazoline derivatives, fatty sulfosuccinate esters or amides, ethoxylated sorbitan esters, alkylamido alkylamines, betaines, alkoxylated alcohols, phosphorous derivatives, quaternary ammonium compounds, ethoxylated alkyl phenols, alkyl ether sulfates, or any combination thereof. Preferred surfactants that can be used in the present cleansing solution include, but are not limited to, PEG 80 glyceryl cocoate, PEG 30 glyceryl cocoate, cocamidopropyl betaine, decyl glucoside, sodium laureth sulfate, or any combinations thereof. Surfactants are preferably present in an amount effective to provide lather.

The present solutions or compositions may also comprise one or more preservatives. The preservatives act to mitigate against unwanted mold or bacteria in the finished product and should be present in an amount effective for this purpose. Any suitable preservatives may be employed, and exemplary preservatives include one or more parabens including methylparaben and propyparaben; organic acids and their derivatives including citric acid, sorbic acids, malic acids; idophors; quaternary ammonium compounds; urea derivatives; isothiazolinones; alkyl substituted amino acids; or any combinations thereof. Preferred preservatives include imidazolidinyl urea, methylparaben, propylparaben, or any combinations thereof.

In addition, the cleansing composition may comprise an acidulant. One such acidulant is citric acid.

The cleansing composition may comprise a fragrance. Any suitable fragrance, e.g., lavender or chamomile, may be employed.

The cleansing solution may comprise a skin conditioner, which is in an ingredient added for purposes of nourishing and soothing the skin and which is added in an amount effective for that purpose. Skin conditioners that can be used in the present cleansing solutions include, but are not limited to, one or more lanolins, polyols including glycerin and sorbitol, botanical derivatives including aloe, vitamins including vitamin E, silicones including dimethicone, quaternary surfactants, esters, mineral oils, petrolatums, C7-C40 branched chain hydrocarbons, C1-C30 alcohol esters of C1-C30 carboxylic acids, C1-C30 alcohol esters of C2-C30 dicarboxylic acids, monoglycerides of C1-C30 carboxylic acids, diglycerides of C1-C30 carboxylic acids, triglycerides of C1-C30 carboxylic acids, ethylene glycol monoesters of C1-C30 carboxylic acids, ethylene glycol diesters of C1-C30 carboxylic acids, propylene glycol monoesters of C1-C30 carboxylic acids, propylene glycol diesters of C1-C30 carboxylic acids, C1-C30 carboxylic acid monoesters and/or polyesters of sugars, polydialkylsiloxanes, polydiarylsiloxanes, polyalkarylsiloxanes, cylcomethicones having 3 to 9 silicon atoms, vegetable oils, hydrogenated vegetable oils, polypropylene glycol C4-C20 alkyl ethers, di C8-C30 alkyl ethers, or any combinations thereof.

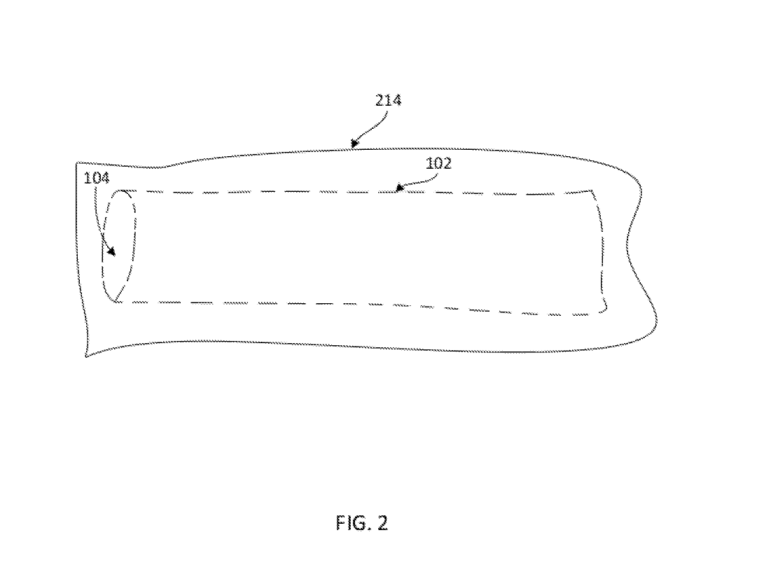

Referring now to FIG. 2, the cleansing sleeve 100 of FIG. 1 is packaged within a water-impermeable package 214. Preferably, the package includes a clear basin and a cover, the clear basin permitting ready identification of the contents of the package on visual inspection and the cover including space for identifying indicia and markings, such as instructions. If desired, as shown in FIG. 3, a kit 300 may be provided, the kit including a first cleansing sleeve 100, a second sleeve 302, and a small disposable basin 304. The first sleeve 100, the second sleeve 302, and the small disposable basin 304 may, for example, enveloped in a water-impermeable package 214. Alternatively, four such sleeves may be provided in a kit, one for each extremity of the patient. The package is water-impermeable, by which is contemplated that the package resists introduction of liquid water until the package is opened. This will assist in preserving the dry nature of the cleansing composition, and in addition, will allow the caregiver to create a small opening in the package to introduce water, if desired, to activate the cleansing composition.

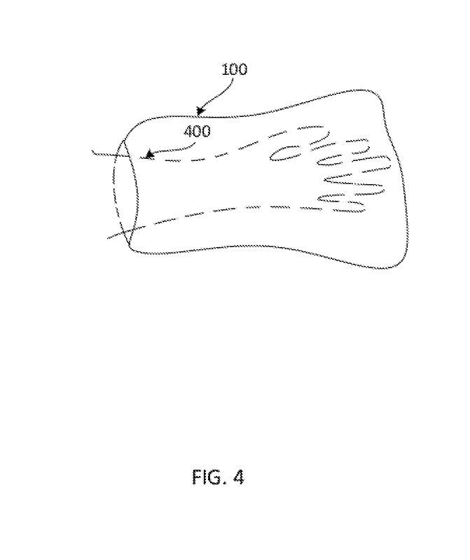

In use, a caregiver, for example, opens a small opening in the water-impermeable package 214 (for example of FIG. 2) and the caregiver adds water to the water-impermeable package 214, or the caregiver removes the cleansing sleeve 100 from the water-impermeable package 214, places the cleansing sleeve 100 into the small disposable basin 304 (for example of FIG. 3) and adds water to the cleansing sleeve 100 in the small disposable basin 304. This activates the cleansing composition, by which is contemplated solubilizing at least a portion of the cleansing composition. The water may be warm tap water. The water is absorbed into the material of the cleansing sleeve 100, activating the dry cleansing composition 108 impregnated in the cleansing sleeve 100. Subsequently, as shown in FIG. 4, the cleansing sleeve 100 of FIG. 1 is placed over a patient's hand 400 or alternatively over the patient's foot (not shown), ideally allowing for 100% of the extremity (limb) to be washed in a soothing and effective manner using the material of the cleansing sleeve 100 and the dry cleansing composition 108 having water absorbed therein.

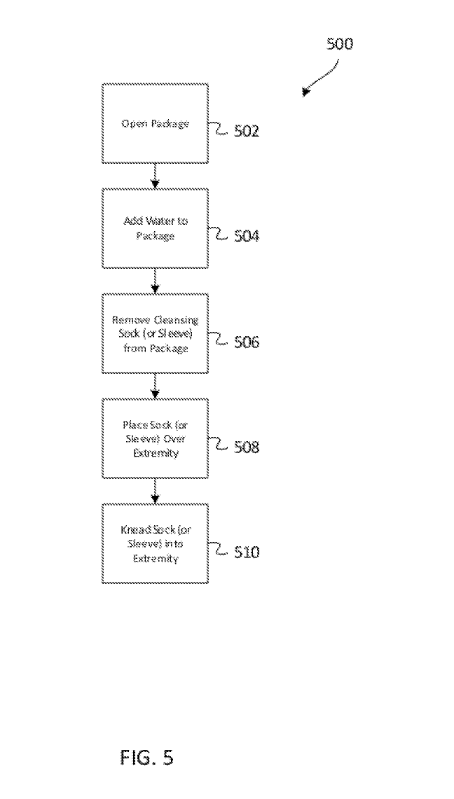

Referring to the method 500 outlined in FIG. 5, at the outset, in a step 502, the user, such as a caregiver, opens the water-impermeable package 214. Next, in a step 504, the caregiver adds water, such as warm water, to the package 214 and the water is absorbed into the material of the cleansing sleeve 100. Next, in a step 506, the caregiver removes the cleansing sleeve 100 from the package 214. After the cleansing sleeve 100 is removed from the package 214, in a step 508, the caregiver slides the cleansing sleeve 100 over the patient's foot or hand, by placing the patient's extremity into the opening 104, allowing for 100% of the extremity to be washed in the soothing and effective manner. To accomplish this cleansing, in a step 510, the caregiver may knead the exterior of the sleeve with his or her fingers so as to work the material of the sleeve and the dry cleansing composition 108 and water into the patient's skin, especially between the patient's toes or fingers.

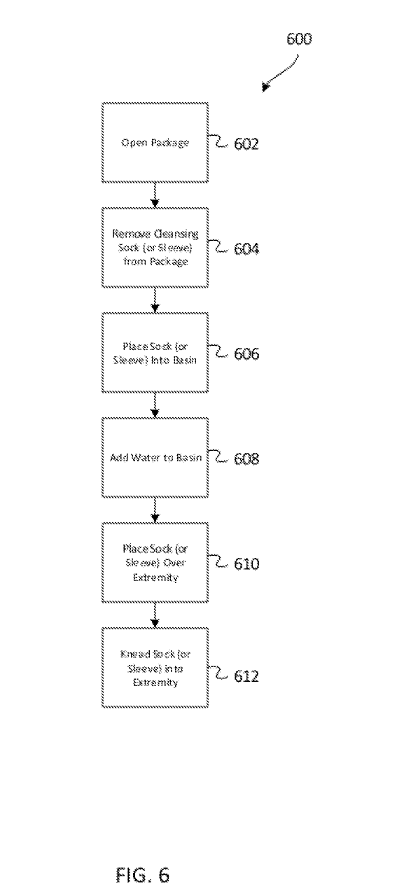

With reference to the alternative process 600 shown in FIG. 6, at the outset, in a step 602, the user, such as a caregiver, opens the package 214 and in a step 604 removes the cleansing sleeve from the package 214. In a step 606, the cleansing sleeve 100 is then placed into a small basin or sink. Next, in a step 608, the caregiver adds water, such as warm water, to the small basin or sink and the water is absorbed into the material of the cleansing sleeve 100. Next, in a step 610, the caregiver slides the cleansing sleeve over the patient's foot or hand, by placing the patient's extremity into the opening 104, again allowing for 100% of the extremity to be washed. The basin may be discarded to avoid potential spillage before transporting the sleeve to the patient. In step 612, the caregiver may knead the exterior of the sleeve with his or her fingers so as to work the material of the sleeve and the dry cleansing composition 108 and water into the patient's skin, and especially between the patient's toes or fingers as before.

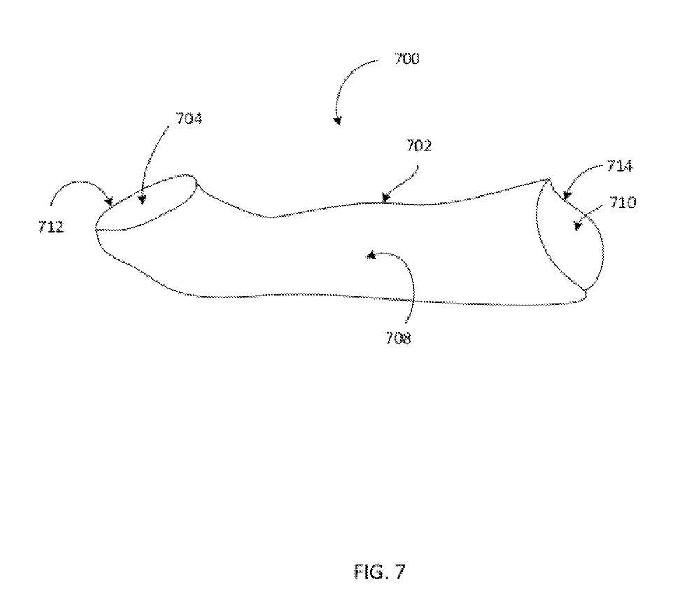

Referring to FIG. 7, shown is a cleansing sleeve 700 made of a polyester blend, or other material impregnated with a dry cleansing composition 708. The cleansing sleeve 700 differs from the cleansing sleeve 100 of FIG. 1 in that the cleansing sleeve 700 is open at both ends, the sleeve 700 including a first opening 704, and a second opening 710.

The cleansing sleeve 700 comprises a tubular section 702 and a first opening 704 sized to accommodate the patient's extremity (limb), such as a hand (see FIG. 3) or foot. The cleansing sleeve 700 also comprises a second opening 710. The diameter of the first opening 704 and the second opening 710 is, for example, less than about half of the length of the cleansing sleeve 700 and is sized to encircle, for example, a human hand or foot in use. The first opening 704 may include elastic 712 encircling the first opening 704 to secure the first opening 704 at the patient's skin, and the second opening 710 may also include elastic 714 in a similar fashion. The tubular section 702 is made from material such as a polyester blend, or other material, impregnated with a dry cleansing composition 708, such as the dry cleansing composition 108 described above with reference to FIG. 1.

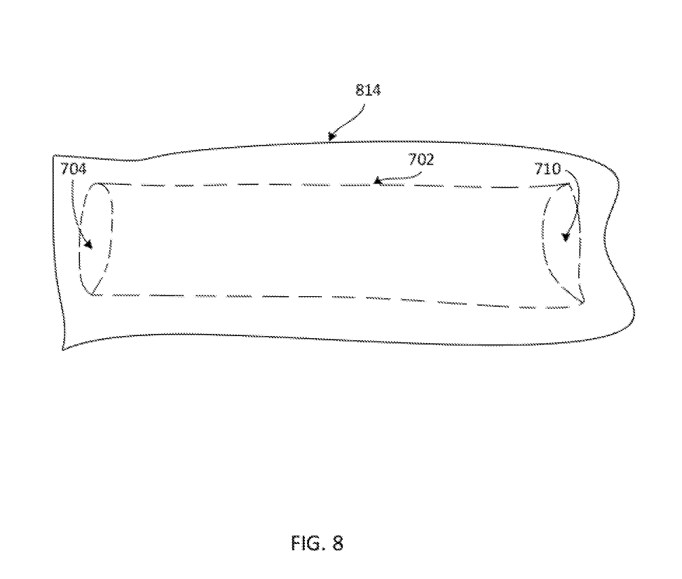

As shown in FIG. 8, the cleansing sleeve 700 of FIG. 7 may be packaged in a water-impermeable package 814, the package being as heretofore described. A kit (not shown here, but otherwise similar in structure and process to the kit 300 described hereinabove) may be provided, the kit including first and second sleeves, optionally third and fourth sleeves, and a small disposable basin, all enveloped in a water-impermeable package. The sleeve 700 and kits may be used substantially as heretofore described with respect to the sleeve of FIG. 1. For example, the methods illustrated in FIGS. 5 and 6 can be employed.

In preparing the cleansing device, first a water-absorbent fabric, such as the nonwoven polyester as heretofore described, is provided and fashioned into the desired shape. This may be done by the manufacturer or the sleeve material may be purchased from a supplier pre-formed. Again, any appropriate morphology may be chosen; generally, the shape chosen may be elongate and generally tubular, having an opening at one or both ends. The method includes introducing a cleansing solution into the water-absorbent sleeve, allowing the cleansing solution to impregnate the sleeve, and allowing the cleansing solution to dry, these steps being performed in any manner appropriate. It is contemplated that heat may be employed to dry the cleansing solution. In any event, the next step is packaging of the cleansing sleeve thus formed within a water-impermeable package. Again, multiple sleeves and a basin may be provided within the package.

In this application all weight percentages are given on a dry solids basis, unless otherwise indicated.

All methods described herein can be performed in any suitable order unless otherwise indicated herein or otherwise clearly contradicted by context. The use of any and all examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A cleansing sleeve suitable for cleansing of a human extremity, comprising:
a tubular section comprising a water-absorbent material; and
a cleansing composition impregnated within the tubular section, the cleansing composition being at least substantially dry, wherein the tubular section comprises at least one open end, whereby the tubular section is sized for insertion of a human hand or foot into the tubular section through the at least one open end.

2. The cleansing device of claim 1, wherein the sleeve comprises a generally elongate tubular section having an open end and a closed end.

3. A device comprising:
a water-impermeable package containing a cleansing sleeve suitable for cleansing of a human extremity, the cleaning sleeve comprising:
a tubular section comprising a water-absorbent material; and
a cleansing composition impregnated within the tubular section, the cleansing composition being at least substantially dry, wherein the tubular section comprises at least one open end, whereby the tubular section is sized for insertion of a human hand or foot into the tubular section through the at least one open end.

4. The device of claim 3, comprising a basin and plural cleansing sleeves disposed within said water-impermeable package.

5. A method for cleansing a human extremity comprising:
providing a water-impermeable package containing a cleansing sleeve suitable for cleansing of a human extremity, the cleansing sleeve comprising:
a tubular section comprising a water-absorbent material; and
a cleansing composition impregnated within the tubular section, the cleansing composition being at least substantially dry, wherein the tubular section comprises at least one open end, whereby the tubular section is sized for insertion of a human hand or foot into the tubular section through the at least one open end;
adding water to solubilize at least a portion of the cleansing composition; and
placing the cleansing sleeve over the hand or foot of a patient.

6. The method of claim 5, comprising adding water to the water-impermeable package, and then removing the cleansing sleeve from the water-impermeable package.

7. The method of claim 5, comprising removing the cleansing sleeve from the package, and placing the sleeve into a basin prior to adding water.

8. A method comprising:
introducing a cleansing solution into a water-absorbent sleeve;
allowing the cleansing solution to impregnate the sleeve;
allowing the cleansing solution to dry to form a cleansing sleeve; and
packaging the cleansing sleeve within a water-impermeable package.

9. A method according to claim 8, further comprising forming a water-absorbent material into the shape of a sleeve to form the water-absorbent sleeve.
